(19) United States
(12) Patent Application Publication
(10) Pub. No.: US 2026/0277006 A1
(43) Pub. Date: Sep. 17, 2026

(54) DEEP-FOCUS GLASSES, XR GLASSES AND CONTACT LENS WITH COLLIMATION FUNCTION

(71) Applicant: ULDTEC CO., LTD., Sendai-shi (JP)

(72) Inventor: Motonobu TAKEYA, Sendai-shi (JP)

(21) Appl. No.: 19/471,513

(22) PCT Filed: Apr. 3, 2024
(86) PCT No.: PCT/JP2024/013692

§ 371 Date: Oct. 1, 2025

(30) Foreign Application Priority Data
Oct. 11, 2023 (JP) 2023-175680
Jan. 11, 2024 (JP) 2024-002461

(51) Int. Cl. G02B 27/01; G02B 27/30

(52) U.S. Cl. CPC G02B 27/0176; G02B 27/0172; G02B 27/30; G02B 2027/0136; G02B 2027/0154; G02B 2027/0178; G02B 2027/0187; G02B 2027/0196

(57) ABSTRACT

The deep-focus glasses have a transparent left-eye housing and a transparent right-eye housing (20) that are integral with a frame (10), a transparent column assembly (30) that is movably housed inside these housings, and an eye tracking sensor (50) attached to these housings. The transparent column assembly is configured such that a plurality of transparent columns (31) that have a radiation angle of 5 degrees or less for 50% or more of transmitted light with respect to incident light are arranged, and the light that has passed through each transparent column converges to a convergence point. Depending on the result of detection of the position of the pupil of the user's eye by the eye tracking sensor, the transparent column assembly is moved to face the pupil and so that the convergence point is located on the surface or inside of the cornea, inside the eyeball, etc.

### TECHNICAL FIELD

The present invention relates to deep-focus glasses, XR (Cross Reality) glasses and a contact lens with collimation function.

### BACKGROUND ART

It is necessary to select the appropriate power of lens according to the user's eyesight in glasses. In addition, the shape of the lens used differs between farsighted and nearsighted users. In bifocal glasses, different lenses are installed in a frame, and the viewing position must be changed depending on the distance or closeness of the object. In addition, the lenses must be changed as the user's eyesight changes.

On the other hand, when it comes to XR glasses such as VR (Virtual Reality) glasses, MR (Mixed Reality) glasses, and the like, which combines real images captured by an image sensor with virtual images and projects them on a near-eye display in front of the user's eyes, lenses are required to focus the user's eyes on the near-eye display, so a certain distance must be secured between the display and the eyes. In general, normal convex lenses are replaced with Fresnel lenses or pancake lenses to make them thinner, but most of them are still bulky like ski goggles and are inconvenient for normal use, so further thinning is desired.

In recent years, a head mounted display in which an angle-selecting type transmission element is arranged in the optical path of an electronic viewfinder has been proposed (see Patent Literature 1). The angle-selecting type transmission element is provided at a location facing the eye point and has a plurality of openings as a limiting means for limiting the passing direction of light to a predetermined range. In the angle-selecting type transmission element, the limiting angle range of the passing direction of light is different in at least two regions, and it is possible to limit or block light from direction other than the eye point. However, this head mounted display uses a convex lens to focus on images of a near-eye display, and has the same problems as the above-mentioned VR glasses and MR glasses. In addition, this head mounted display is configured such that it is not easy to secure a sufficiently wide eye box. Proposed also is a head mounted display, comprising: a display element, a shutter mechanism that interposes a plurality of optical local openings between a pupil assumed region having the position and size of the pupils of both eyes assumed when worn and the display element, and that switches the position of the local openings at high speed with time; and a display control unit that switches the display position of a partial image on the display surface of the display element at high speed in synchronization with the position of the local openings of the shutter mechanism (see Patent Literature 2). Patent Literature 2 describes that the problem of the inconsistency between the convergence angle of the eyes and the focal length can be alleviated by deep-focusing using a pinhole. However, this head mounted display is not easily made thin and lightweight, and the usage environment (conditions) is limited. In the case of XR glasses, it will be difficult to popularize them widely unless they are thin and lightweight devices like glasses or sunglasses.

### PRIOR ART LITERATURE

### Patent Literature

[PATENT LITERATURE 1] Laid-open publication No. 2022-46404

[PATENT LITERATURE 2] Laid-open publication No. 2011-145607

### SUMMARY OF INVENTION

### Summary to be Solved by Invention

The subject to be solved by this invention is to provide deep-focus glasses that dramatically reduce the mixed ratio of light and provide a clear field of vision with little blur from long distances to very close distances by viewing the outside world through a transparent column assembly that transmits only light within a certain radiation angle instead of normal lenses of glasses.

Another subject to be solved by this invention is to provide XR glasses that enable image recognition at an overwhelmingly closer distance than with conventional optical systems by viewing images of a near-eye display through a transparent column assembly that transmits only light within a certain radiation angle, and that can realize VR glasses, MR glasses, and the like that are not much different in thickness from normal glasses and are not bulky.

Yet another subject to be solved by this invention is to provide a contact lens with collimation function that can be used in combination with an XR glasses main body to recognize images with sufficient resolution, and XR glasses using the contact lens with collimation function.

### Means to Solve the Subjects

In order to solve the subject, according to the invention, there is provided deep-focus glasses, comprising:
a transparent left-eye housing and a transparent right-eye housing that are integral with a frame,
a transparent column assembly that is movably housed in the left-eye housing and the right-eye housing, respectively; and
at least one eye tracking sensor that is attached to each of the left-eye housing and the right-eye housing,
the transparent column assembly being configured such that a plurality of transparent columns serving as collimators are arranged, the transparent columns having a radiation angle of 5 degrees or less for 50% or more of transmitted light with respect to incident light, and the light transmitted through each transparent column is converged to a convergence point,
the deep-focus glasses having the function of moving the transparent column assembly inside the left-eye housing and the right-eye housing so that it faces the pupil and the convergence point is located on the surface or inside of the cornea, inside the pupil, on the surface or inside of the crystalline lens, or inside the eyeball, depending on the result of detection of the position of the pupil of the user's eye by the eye tracking sensor.

Typically, the inside of the left-eye housing and the right-eye housing is filled with a liquid having a refractive index equivalent to that of the transparent column, and the transparent column assembly is suspended in the liquid. The liquid filled in the inside of the left-eye housing and the right-eye housing is selected as necessary in consideration of the material of the transparent columns constituting the transparent column assembly, and examples of the liquid include silicone oil (refractive index 1.4 to 1.58, viscosity 1 to tens of thousands mPa-s), immersion oil (refractive index about 1.5, viscosity 150 to tens of thousands mPa-s), water (refractive index 1.33, viscosity about 1 mPa-s), and alcohol (refractive index about 1.4, viscosity 0.5 to 0.8 mPa-s). Typically, the transparent column assembly can be composed of a transparent column assembly in which a large number of transparent columns in the shape of a regular hexagonal truncated pyramid are arranged on a curved surface in a honeycomb shape so that the side surfaces are in close contact with each other. A light-absorbing film is provided on the side surface of each transparent column. The material of the transparent columns is selected as necessary, and may be, for example, thermoplastic acrylic resin (PMMA), polycarbonate (PC) resin, polydimethylsiloxane (PDMS), and the like. The refractive index of these materials is 1.4 to 1.6. The transparent columns may be a cavity made of air. The material of the light-absorbing film is selected as necessary, and may be, for example, black resist.

The transparent column assembly can be configured to be movable by magnetic or electric force. When the transparent column assembly is moved by magnetic force, for example, micro magnets are attached to a plurality of positions of the transparent column assembly, and a plurality of micro coils are attached to at least one of the front and rear surfaces of the left-eye housing and the right-eye housing so that they can be driven independently of each other. Typically, the micro coils are arranged in a two-dimensional array. The micro magnets are typically attached to at least three positions of the transparent column assembly. The micro magnets are selected as necessary, but in order to reduce the size, a strong magnet such as a neodymium-based magnet is preferably used. Typically, the micro magnets are attached to a plurality of positions of the transparent column assembly, and a plurality of micro coils are attached to at least one of the front and rear surfaces of the left-eye housing and the right-eye housing so that they can be driven independently of each other. These micro coils are typically arranged in a two-dimensional array, but are not limited thereto. The transparent column assembly may be configured to be movable by mechanically changing the position or angle. For example, a piezo actuator or a motor is connected to the transparent column assembly.

Typically, a near infrared sensor is used as the eye tracking sensor. The eye tracking sensor is typically attached to the four corners of the left-eye housing and the right-eye housing. The eye tracking sensor detects the pupil of the user, thereby detecting the movement of the eyeball, and the transparent column assembly is moved according to the result.

Here, the above-mentioned radiation angle refers to the angle range from the emission direction where the light intensity is at its maximum to where that intensity becomes half, and a light radiation angle of within 5 degrees means that, with the emission direction where the light intensity is at its maximum as the reference (0 degrees), the angle range where the light intensity becomes half is within ±2.5 degrees, or within a range of 5 degrees.

According to the invention, there is provided XR glasses, comprising:
a transparent left-eye housing and a transparent right-eye housing that are integral with a frame,
a transparent column assembly that is movably housed in the left-eye housing and the right-eye housing, respectively,
at least one eye tracking sensor that is attached to each of the left-eye housing and the right-eye housing; and
an opaque or semi-transparent left-eye display and an opaque or semi-transparent right-eye display provided on a front surface of the left-eye housing and the right-eye housing, respectively,
the transparent column assembly being configured such that a plurality of transparent columns serving as collimators are arranged, the transparent columns having a radiation angle of 5 degrees or less for 50% or more of transmitted light with respect to incident light, and the light transmitted through each transparent column is converged to a convergence point,
the XR glasses having the function of moving the transparent column assembly inside the left-eye housing and the right-eye housing so that it faces the pupil and the convergence point is located on the surface or inside of the cornea, inside the pupil, on the surface or inside of the crystalline lens, or inside the eyeball, depending on the result of detection of the position of the pupil of the user's eye by the eye tracking sensor.

The term “XR glasses” is a general term for glasses that use technologies such as VR, AR (Augmented Reality Reality), MR, SR (Substitutional Reality) or intermediate technologies between these technologies (for example, technologies positioned between AR and MR) and XR glasses correspond to an image display device that creates a space that provides a simulated experience by fusing the real and virtual worlds. AR is a technology that projects a virtual world onto real space to show, MR is a technology that fuses real space and virtual space to show, and SR is a technology that overlays past images onto real space to show, making it appear as if a past event is happening right in front of your eyes.

The left-eye display and the right-eye display as the near-eye displays are, for example, liquid crystal displays (LCD), organic electroluminescence (EL) displays, micro light emitting diode (LED) displays, and the like.

In the invention of the XR glasses, other than the above, the explanation concerning the above invention of the deep-focus glasses comes into effect.

According to the invention, there is provided deep-focus glasses, comprising:
a left-eye lens or non-lens member and a right-eye lens or non-lens member that are integral with a frame; and
a transparent column assembly that is provided on the front or rear surface of the left-eye lens or non-lens member and the front or rear surface of the right-eye lens or non-lens member, respectively,
the transparent column assembly being configured such that a plurality of transparent columns serving as collimators are arranged, the transparent columns having a radiation angle of 5 degrees or less for 50% or more of transmitted light with respect to incident light, and the light transmitted through each transparent column is converged to a convergence point,
the convergence point being located on the surface or inside of the cornea, inside the pupil, on the surface or inside of the crystalline lens, or inside the eyeball.

The left-eye lens and the right-eye lens may be convex or concave lenses, and may have prescription or no prescription. The left-eye non-lens member and the right-eye non-lens member are, for example, windshields (transparent or semi-transparent plastic or glass members without lens function).

In the invention of the deep-focus glasses, other than the above, the explanation concerning the above invention of the deep-focus glasses comes into effect.

According to the invention, there is provided XR glasses, comprising:
an XR glasses main body having a left-eye display unit and a right-eye display unit each of which is made up of a semi-transparent micro light emitting diode display having a pixel array in which one pixel is formed by at least three or more sub-pixels and one or more micro light emitting diodes included in each of the sub-pixels, the aperture ratio of the pixel being 10% or more; and
contact lenses with collimation function, each contact lens having a radiation angle of 5 degrees or less for 50% or more of transmitted light with respect to light emitted from an arbitrary point of the left-eye display unit and the right-eye display unit.

The contact lenses with collimation function may be basically configured in any way as long as they can make the radiation angle for 50% or more of transmitted light 5 degrees or less for light emitted from an arbitrary point of the left-eye display unit and the right-eye display unit. Typically, the part (central part) of the contact lenses with collimation function excluding the outer periphery can be configured by a transparent column assembly in which a large number of transparent columns in the shape of a regular hexagonal truncated pyramid are arranged on a curved surface corresponding to the surface of the cornea in a honeycomb shape so that the sides of the transparent columns are in close contact with each other. A light-absorbing film is provided on the side of each transparent column. In this case, preferably, when the contact lenses with collimation function is attached to the cornea, the convergence point of the light passing through each transparent column of the contact lenses with collimation function is located near the center of the crystalline lens. The closer the convergence point is to the center of the eyeball, the narrower the field of view becomes, but if the contact lens with collimation function is designed and manufactured so that the convergence point of the transmitted light is located near the center of the crystalline lens, a sufficiently wide field of view can be ensured. The shape of the outer frame of the transparent column assembly can be any shape, such as circle, ellipse, square, rectangle, polygon, and the like and can be designed appropriately according to the specifications (such as product design).

When the contact lenses with collimation function are attached to the cornea and the XR glasses main body is placed in front of the eye, light from the micro light emitting diode enters one end of the transparent column of the contact lenses with collimation function and exits from the other end, allowing light with a radiation angle of 5 degrees or less to enter the crystalline lens.

Light has wave properties, and therefore there are diffraction phenomena. Further, some light passes through light-absorbing films. As a result, some light passes beyond the geometrically designed angle. Therefore, a radiation angle of 5 degrees or less means that the radiation angle range with a transmittance of 50% or more is 5 degrees or less (±2.5 degrees or less) based on the direction of light emitted from an arbitrary point on the display toward the convergence point of light passing through each transparent column of the above-mentioned contact lenses with collimation function.

In the invention of the XR glasses, other than the above, the explanation concerning the above-mentioned invention of the XR glasses comes into effect unless it is contrary to its character.

According to the invention, there is provided a contact lens with collimation function having a radiation angle of 5 degrees or less for 50% or more of transmitted light with respect to light emitted from an arbitrary point.

When wearing the contact lens with collimation function, the amount of light entering the eye is reduced, but the user can see clearly from far away to very close. Since it can correct both farsightedness and nearsightedness at the same time, it can also be used as a contact lens in everyday life. The above-mentioned collimation function can be added to a contact lens with normal lens functions (shapes).

In addition, the focal range has been expanded, allowing images of a near-eye display to be recognized regardless of the presence or absence of a lens that generates a virtual image. It can also be used with VR glasses, making it possible to make the VR glasses thinner by eliminating a large lens that generates a virtual image.

In the invention of the contact lens with collimation function, other than the above, the explanation concerning the above-mentioned invention of the XR glasses comes into effect unless it is contrary to its character.

### Effect of the Invention

According to the deep-focus glasses of the invention, instead of using normal lenses of glasses, the outside world can be seen through a transparent column assembly that transmits only light within a certain radiation angle, dramatically reducing the mixed ratio of light and thereby providing a clear field of vision with little blur from long distances to extremely close distances.

According to the XR glasses of the invention, by viewing images of a near-eye display through a transparent column assembly that transmits only light within a certain radiation angle, it is possible to recognize images at an overwhelmingly closer distance than with conventional optical systems, and it is possible to realize VR glasses, MR glasses, and the like that are not much different in thickness from normal glasses and are not bulky.

According to the contact lens with collimation function of the invention, the transmittance of light having a radiation angle of at least larger than 5 degrees (±2.5 degrees) from the direction toward the convergence point of the light passing through each transparent column of the contact lenses is attenuated to 50% or less with respect to light reflected or emitted from an arbitrary point in space, so that when the contact lens is attached to the cornea, a clear image of an arbitrary point can be formed on the retina from long distances to close distances. By combining the contact lens with an XR glasses main body, it is possible to realize XR glasses that can display images with sufficient resolution even without using a collimator in the XR glasses main body.

### BRIEF DESCRIPTION OF THE DRAWINGS

FIG. 1 A left side view showing deep-focus glasses according to a first embodiment of the invention.

FIG. 2 A front view showing a left-eye housing of the deep-focus glasses according to the first embodiment of the invention.

FIG. 3A A plan view showing a transparent column assembly contained inside the left-eye housing of the deep-focus glasses according to the first embodiment of the invention.

FIG. 3B A cross-sectional view showing the transparent column assembly contained inside the left-eye housing of the deep-focus glasses according to the first embodiment of the invention.

FIG. 3C A plan view showing transparent columns constituting the transparent column assembly contained inside the left-eye housing of the deep-focus glasses according to the first embodiment of the invention.

FIG. 3D A side view showing the transparent columns constituting the transparent column assembly contained inside the left-eye housing of the deep-focus glasses according to the first embodiment of the invention.

FIG. 4A A cross-sectional view for explaining a method of manufacturing the transparent column assembly contained inside the left-eye housing of the deep-focus glasses according to the first embodiment of the invention.

FIG. 4B A cross-sectional view for explaining the method of manufacturing the transparent column assembly contained inside the left-eye housing of the deep-focus glasses according to the first embodiment of the invention.

FIG. 4C A cross-sectional view for explaining the method of manufacturing the transparent column assembly contained inside the left-eye housing of the deep-focus glasses according to the first embodiment of the invention.

FIG. 4D A cross-sectional view for explaining the method of manufacturing the transparent column assembly contained inside the left-eye housing of the deep-focus glasses according to the first embodiment of the invention.

FIG. 4E A cross-sectional view for explaining the method of manufacturing the transparent column assembly contained inside the left-eye housing of the deep-focus glasses according to the first embodiment of the invention.

FIG. 5 A schematic view showing an example of wiring of a micro coil array of a magnetic field generating coil array substrate provided on the front and rear surfaces of the left-eye housing of the deep-focus glasses according to the first embodiment of the invention.

FIG. 6 A schematic view showing a state in which a user wears the deep-focus glasses according to the first embodiment of the invention.

FIG. 7 A schematic view showing a state in which a user wearing the deep-focus glasses according to the first embodiment of the present invention has his/her line of sight directed downward and his/her eyeballs rotated.

FIG. 8 A front view showing the left-eye housing of the deep-focus glasses according to the first embodiment of the invention in the state shown in FIG. 7.

FIG. 9 A left side view showing XR glasses according to a second embodiment of the invention.

FIG. 10 A schematic view showing a state in which a user wears the XR glasses according to the second embodiment of the invention.

FIG. 11 A left side view showing deep-focus glasses according to a third embodiment of the invention.

FIG. 12 A schematic view showing a state in which a user wears the deep-focus glasses according to the third embodiment of the invention.

FIG. 13 A left side view showing deep-focus glasses according to a fourth embodiment of the invention.

FIG. 14 A schematic view showing a state in which a user wears the deep-focus glasses according to the fourth embodiment of the invention.

FIG. 15 A left side view showing deep-focus glasses according to a fifth embodiment of the invention.

FIG. 16 A schematic view showing a state in which a user wears the deep-focus glasses according to the fifth embodiment of the invention.

FIG. 17 A schematic view showing a state in which a user wearing the deep-focus glasses according to the fifth embodiment of the invention has his/her line of sight directed downward and his/her eyeballs rotated.

FIG. 18 A right side view showing an XR glasses main body according to a sixth embodiment of the invention.

FIG. 19 A perspective view showing a lateral micro LED used in a semi-transparent micro LED display for XR glasses in the XR glasses main body according to the sixth embodiment of the invention.

FIG. 20A A plan view showing a contact lens with collimation function of the XR glasses according to the sixth embodiment of the invention.

FIG. 20B A cross-sectional view showing the contact lens with collimation function of the XR glasses according to the sixth embodiment of the invention.

FIG. 20C A plan view showing transparent columns constituting the contact lens with collimation function of the XR glasses according to the sixth embodiment of invention.

FIG. 20D A side view showing the transparent columns constituting the contact lens with collimation function of the XR glasses according to the sixth embodiment of the present invention.

FIG. 21A A cross-sectional view for explaining a method of manufacturing the contact lens with collimation function of the XR glasses according to the sixth embodiment of the invention.

FIG. 21B A cross-sectional view for explaining the method of manufacturing the contact lens with collimation function of the XR glasses according to the sixth embodiment of the present invention.

FIG. 21C A cross-sectional view for explaining the method of manufacturing the contact lens with collimation function of the XR glasses according to the sixth embodiment of the invention.

FIG. 21D A cross-sectional view for explaining the method of manufacturing the contact lens with collimation function of the XR glasses according to the sixth embodiment of the invention.

FIG. 21E A cross-sectional view for explaining the method of manufacturing the contact lens with collimation function of the XR glasses according to the sixth embodiment of the invention.

FIG. 22 A schematic view showing a state in which the contact lens with collimation function of the XR glasses according to the sixth embodiment of the invention is worn on the cornea by a user.

FIG. 23 A schematic view showing a state in which the XR glasses according to the sixth embodiment of the invention is worn in front of the user's eyes.

FIG. 24 A schematic view showing a state in which the XR glasses according to the sixth embodiment of the invention is worn in front of the user's eyes.

### MODES FOR CARRYING OUT THE INVENTION

Modes for carrying out the invention (hereinafter referred as embodiments) will now be explained below.

### THE FIRST EMBODIMENT

### Deep-Focus Glasses

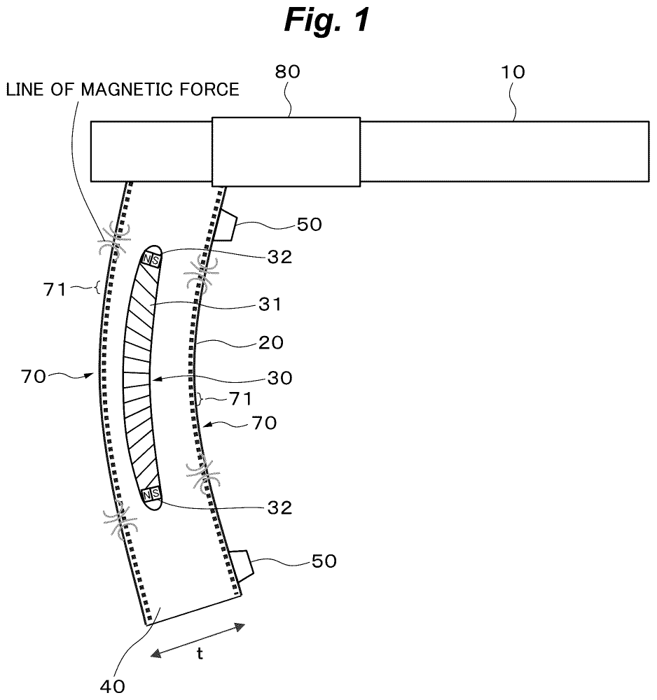

FIG. 1 is a left side view showing the deep-focus glasses according to the first embodiment. Since the deep-focus glasses are configured symmetrically, the configuration of the left-eye side will be described below.

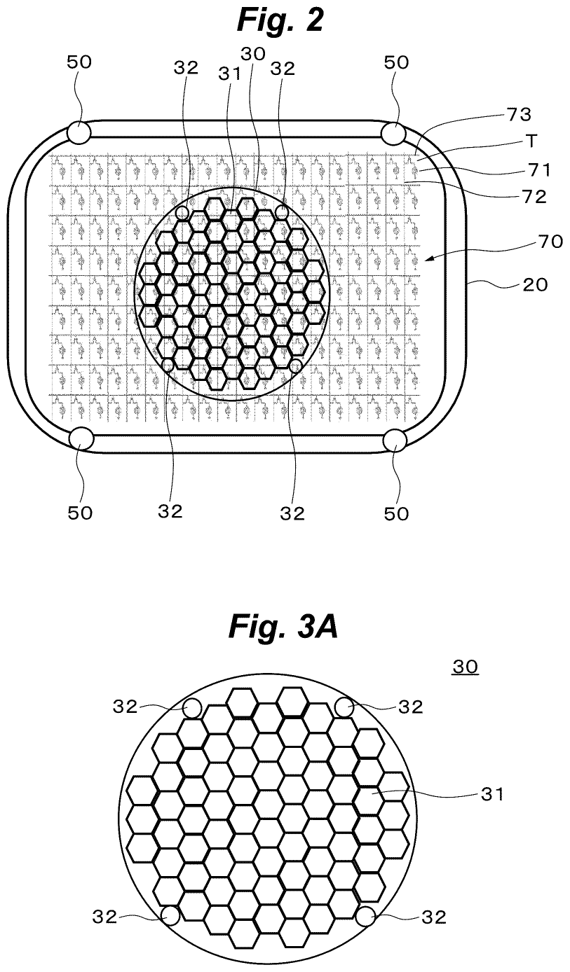

As shown in FIG. 1, in the deep-focus glasses, a transparent column assembly 30 is movably housed inside a transparent left-eye housing 20 integrated with a frame 10. The left-eye housing 20 has a curved shape with a convex front as a whole. A liquid 40 is filled inside the left-eye housing 20, and the transparent column assembly 30 is suspended in the liquid 40. The liquid 40 has a refractive index equivalent to that of the transparent material of the transparent column assembly 30, and is selected from the above-mentioned materials as necessary. FIG. 2 shows an example of the rear surface of the left-eye housing 20, that is, a front view seen from the face side when the user wears the deep-focus glasses. As shown in FIG. 2, the left-eye housing 20 has a rectangular shape with rounded corners when viewed from the front. In this state, the transparent column assembly 30 is located approximately in the center of the left-eye housing 20. The thickness t of the left-eye housing 20 is selected as necessary, and is, for example, 3 to 5 mm. As shown in FIG. 1 and FIG. 2, an eye tracking sensor 50 is attached to each of the four corners of the rear surface of the left-eye housing 20. The eye tracking sensor 50 is a near-infrared sensor and is capable of detecting the position of the pupil.

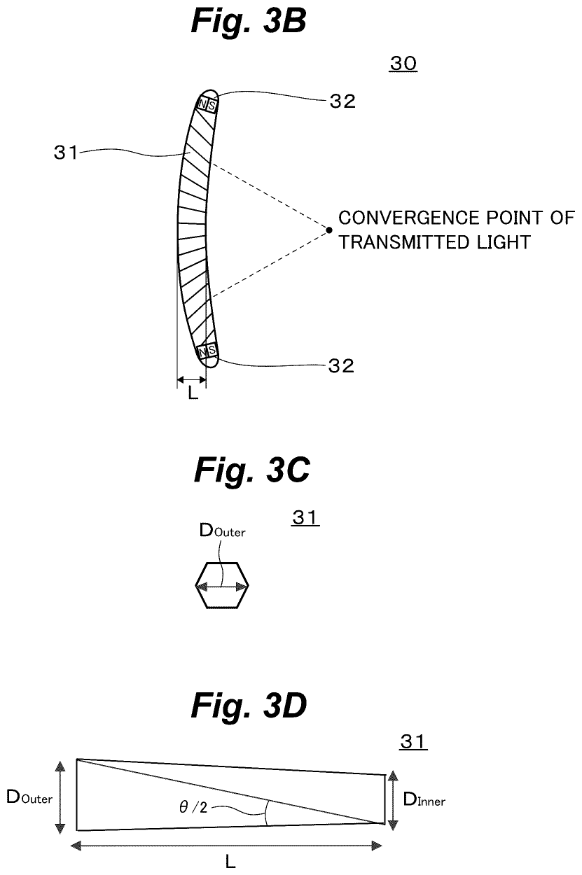

FIG. 3A, FIG. 3B, FIG. 3C and FIG. 3D show the transparent column assembly 30, with FIG. 3A and FIG. 3B being plan and cross-sectional views of the transparent column assembly 30, respectively, and FIG. 3C and FIG. 3D being plan and side views of a transparent column 31 serving as a collimator of the transparent column assembly 30, respectively.

As shown in FIG. 3A and FIG. 3B, the transparent column assembly 30 has a circular shape curved into a bowl shape as a whole. The outer periphery of the transparent column assembly 30 is made of the same material as the transparent columns 31, and micro magnets 32 are attached to the outer periphery at four locations such that they go through the outer periphery, respectively. In FIG. 3B, the magnetic poles of the micro magnets 32 are N pole on the curved convex side and S pole on the concave side, but this is not limited to this and the polarity may be reversed. The diameter of the transparent column assembly 30 is, for example, 12 to 22 mm, and the thickness L is, for example, 0.1 to 0.5 mm, but this is not limited to this.

The transparent column assembly 30 is formed by arranging a large number of transparent columns 31 in a regular hexagonal truncated pyramid shape, as shown in FIG. 3C and FIG. 3D, in a honeycomb shape with their sides in close contact with each other. The curved outer and inner surfaces of the transparent column assembly 30 are smoothly formed. If the diagonal length of the outer surface of the transparent column 31 is denoted as D_{Outer} and the diagonal length of the inner surface is denoted as D_{Inner}, D_{Outer}>D_{Inner}.

As shown in FIG. 3B, the transparent column assembly 30 is configured so that the light passing through each transparent column 31 constituting the transparent column assembly 30 converges to one point (convergence point). When the user wears the deep-focus glasses, the convergence point where the light passing through each transparent column 31 converges is set to be located on the surface or inside of the cornea, inside of the pupil, on the surface or inside of the crystalline lens, or inside the eyeball.

Each transparent column 310 constituting the transparent column assembly 30 is configured so that the radiation angle of light from each transparent column 31 is within 5 degrees. As shown in FIG. 3C and FIG. 3D, the length of the transparent column 31 is denoted as L, and half the radiation angle is denoted as θ/2. The design conditions for the transparent column 31 are typically L/D_{Outer}≥23 and D_{Outer}>D_{Inner}. Under these conditions, the collimation angle θ is within 5 degrees, the range of L is, for example, 0.046 to 0.5 mm, and the ranges of D_{Outer} and D_{Inner} are, for example, 2 to 22 μm.

The condition of the light radiation angle of 5 degrees corresponds to the radiation angle of light incident on the pupil from a light source about 92 mm away when the pupil diameter is 8 mm. This is the range where some people can focus on the retina with the crystalline lens, but generally, the distance where a person can comfortably focus on the retina is about 230 mm. In this case, the radiation angle of light incident on the pupil is about 2 degrees when the pupil diameter is 8 mm. Therefore, the design condition of each transparent column 31 of the transparent column assembly 30 is more preferably the condition of θ≤2.0 degrees, that is, L/D_{Outer}≥57.3. The narrower the radiation angle θ of the transmitted light, the better the deep-focus performance. However, since the narrower the radiation angle of light, the more the transmitted light amount is reduced, it is desirable that the radiation angle θ of the light passing through each transparent column 31 is 0.1 degrees or more. It is also possible to increase the transmitted light amount by narrowing the radiation angle of light in advance by installing a micro lens array before the light enters each transparent column 31, but details will be omitted.

The transparent material of the transparent column assembly 30 is, for example, thermoplastic acrylic resin (PMMA) or polycarbonate (PC) resin, and the material of the light-absorbing film on the side of the transparent column 31 is, for example, black resist or a material made by mixing carbon black with thermoplastic resin.

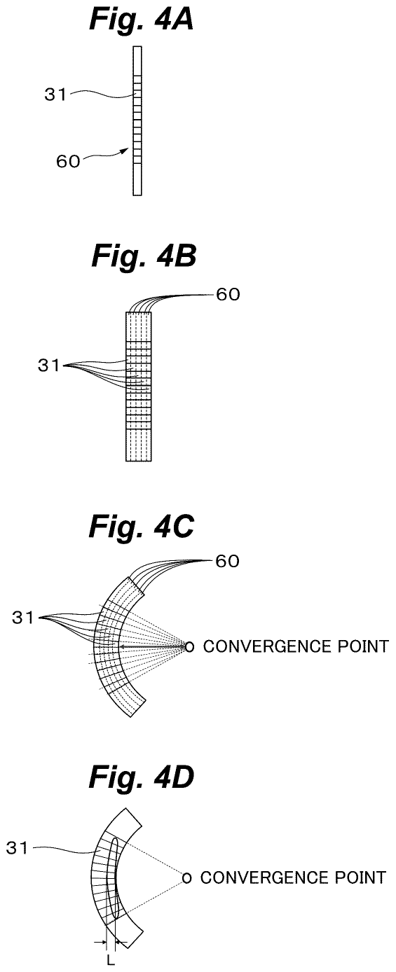

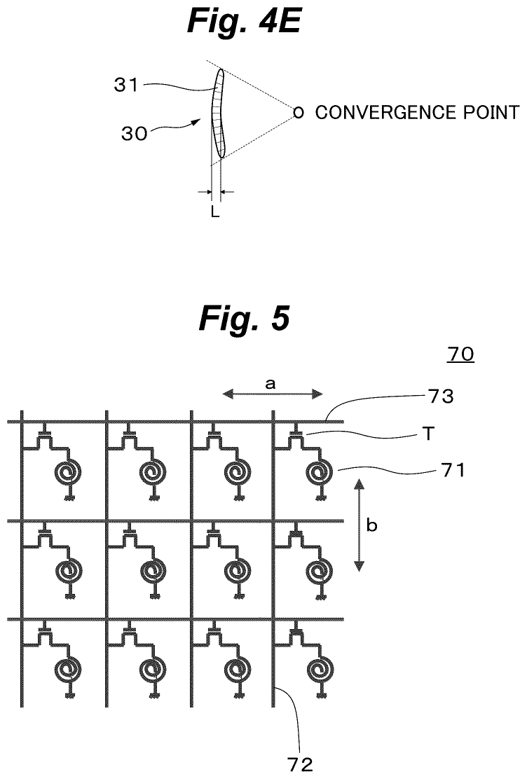

A method for manufacturing the transparent column assembly 30 will be described. In order to achieve a radiation angle of 5 degrees or less, the aspect ratio of the transparent columns 31 serving as collimators needs to be increased to about 23 or more, and it is difficult to collectively form them. For this reason, for example, as shown in FIG. 4A, a flat and stretchable transparent layer 60 having a transparent column assembly consisting of transparent columns 31 in the shape of regular hexagonal columns whose side walls are formed of a light-absorbing film (not shown) is formed, and this is stacked in multiple layers (three layers in this example) as shown in FIG. 4B to form a thick film of a transparent column assembly with collimation function with a sufficient thickness to make the radiation angle 5 degrees or less. The thick film is cut into a disk shape of an appropriate size, and is curved by heating and molding. This state is shown in FIG. 4C. By this process, the area of the transparent column assembly becomes a shape in which the outside of the curved surface is wide and the inside is narrow. The convergence point of the light passing through the transparent column assembly can be adjusted by the radius of curvature of the curve at this time. The radius of curvature is selected depending on where the convergence point is to be located, but is typically about 12 to 30 mm. Next, as shown in FIG. 4D, the excess portions of the inner curved surface and the outer curved surface of the thick film are ground away. If necessary, as shown in FIG. 4E, the outer periphery of the transparent column assembly 30 is chamfered. After this, through holes are formed in four places on the outer periphery of the transparent column assembly 30, and micro magnets 32 are inserted and fixed in these through holes. In this way, the desired transparent column assembly 30 is manufactured.

As shown in FIG. 1 and FIG. 2, a coil array substrate 70 is provided on the front and rear surfaces of the left-eye housing 20 on the liquid 40 side, respectively. The coil array substrate 70 is a transparent substrate such as a transparent film on which a large number of micro coils 71 for generating a magnetic field are arranged in a two-dimensional matrix. FIG. 5 shows the details of the coil array and its active drive circuit of the coil array substrate 70. As shown in FIG. 5, a large number of power lines 72 extending in the column direction and scanning lines 73 extending in the row direction are provided vertically and horizontally on the transparent substrate. The intervals a and b between the micro coils 71 are, for example, 10 to 100 μm. The active drive circuit is made up of a switching transistor T. The switching transistor T is generally made up of a thin film transistor using a semiconductor thin film such as a polycrystalline or amorphous Si thin film. The source of the switching transistor T is connected to the power line 72, the drain is connected to one end of the micro coil 71, and the gate is connected to the scanning line 73. The other end of the micro coil 71 is grounded. One or more micro coils 71 are selected by selecting the scanning line 73 and the power line 72. A current flows from the power line 72 through the switching transistor T to the selected micro coil 71, and the magnetic field penetrating the micro coil 71 is controlled by controlling the current value by a gate voltage applied to the scanning line 73. FIG. 1 shows a schematic diagram of lines of magnetic force penetrating the micro coil 71. The transparent column assembly 30 can be moved in the liquid 40 by the attractive or repulsive force generated between the magnetic field generated by the micro coil 71 and the micro magnets 32 attached to the four corners of the transparent column assembly 30, and the position, angle, and the like can be adjusted. In this way, by controlling the magnetic force acting on the four micro magnets 32 of the transparent column assembly 30 by selecting the micro coil 71, the transparent column assembly 30 can be easily moved to a desired position and orientation.

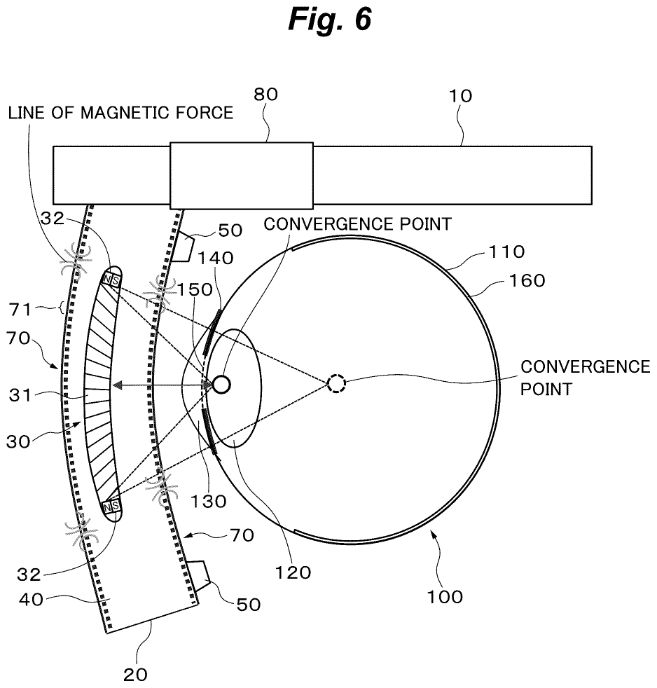

FIG. 6 shows a state when the deep-focus glasses are worn by a user. In FIG. 6, the left eye 100 has an eyeball 110, a crystalline lens 120, a cornea 130, an iris 140, a pupil 150, and a retina 160. If the eyeball 110 is assumed to be a sphere, its diameter is about 24 mm. The crystalline lens 120 has a diameter of about 9 mm and a thickness of about 3.6 mm (4.0 mm at maximum accommodation). The retina 160 spreads over a length of 30 to 40 mm. The distance from the outer surface (front surface) of each transparent column 31 of the transparent column assembly 30 to the convergence point of the light transmitted through each transparent column 31 is, for example, 12 mm when the convergence point is near the surface of the cornea 130, 16 mm when the convergence point is near the surface of the pupil 150, 18 mm when the convergence point is near the center of the crystalline lens 120, and 30 mm when the convergence point is near the center of the eyeball 110.

The ear hook on the left side of the frame 10 is provided with a control circuit unit 80 for controlling the operation of the coil array substrate 70, and therefore the operation of the transparent column assembly 30. The control circuit unit 80 may also be provided with a wireless communication unit as necessary. Although not shown, a flexible wiring is provided on the side of the frame 10 including the ear hook for wiring between the coil array substrate 70 and the eye tracking sensor 50 and the control circuit unit 80. A battery (such as a lithium ion battery) used as a power source is attached to any part of the frame 10 (for example, the ear hook, and the like), but is not limited thereto. A power source or a complex control circuit unit, which tend to be bulky, may be connected to the main body (frame 10) by providing a separate base, such as hanging it around the neck. Although not shown, a nose pad is provided on the nose side of the frame 10.

### Operation of the Deep-Focus Glasses

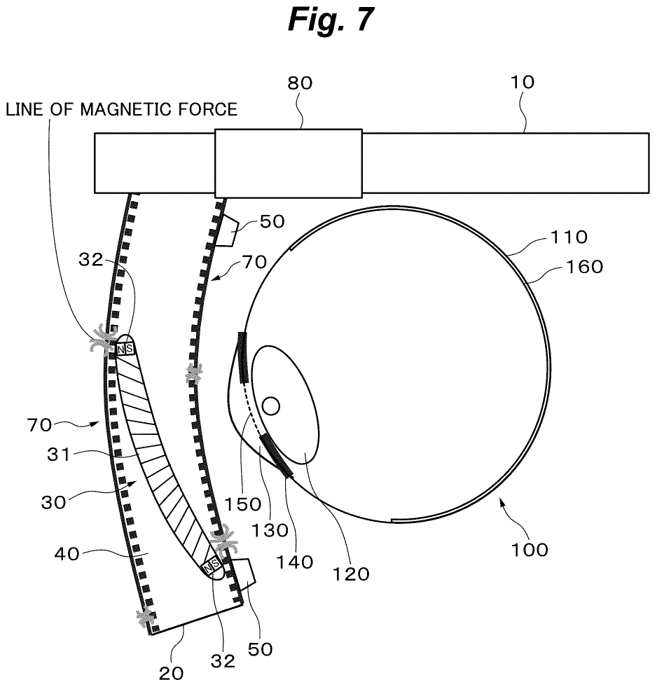

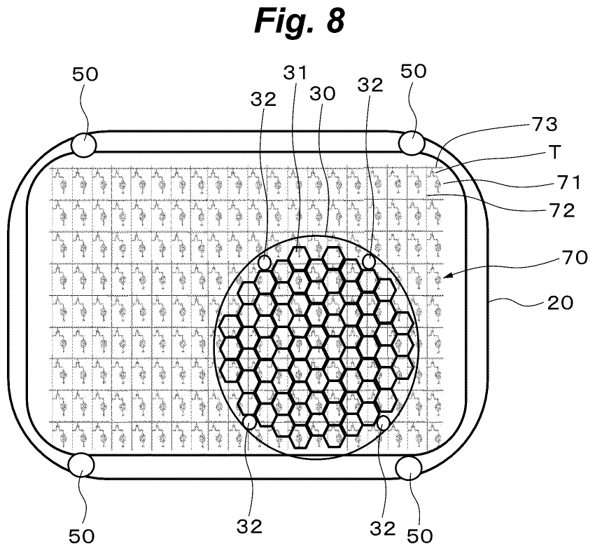

As shown in FIG. 6, when light from the outside world enters through the front surface of the left-eye housing 20, the radiation angle is narrowed to within 5 degrees by each transparent column 31 when it enters the transparent column assembly 30, and after passing through the convergence point, it forms an image on the retina 160. FIG. 7 shows a state in which the line of sight is turned downward and the eyeball 110 is rotated compared to FIG. 6. As shown in FIG. 7, even if the line of sight is turned downward and the eyeball 110 is rotated, the transparent column assembly 30 can be moved by magnetic force inside the liquid 40 of the left-eye housing 20 in response to this rotation, so that the light transmitted through the transparent column assembly 30 can reliably pass through the pupil 150. More specifically, the eye tracking sensor 50 detects the pupil 150 to detect the movement of the eyeball 110, and sends the detection signal to the control circuit unit 80. The control circuit unit 80 sends a control signal corresponding to this detection signal to the coil array substrate 70, and a selected current is passed through the micro coil 71 selected by the coil array substrate 70. This allows the transparent column assembly 30 to move to the desired position and orientation. A front view of this state corresponding to FIG. 2 is shown in FIG. 8. As shown in FIG. 8, it can be seen that the transparent column assembly 30, which was near the center in the state of FIG. 2, has moved to the lower right. In this way, by being able to move the transparent column assembly 30 to the optimal position and orientation in response to the movement of the eyeball 110, a wide eyebox (visible range) can be maintained.

As described above, according to the deep-focus glasses of the first embodiment, instead of using normal lenses of glasses, the outside world can be seen through the transparent column assembly 30 that can narrow the radiation angle of light from the outside world to within 5 degrees substantially, so that the light mixing ratio can be drastically reduced, and therefore a clear field of view with sufficient resolution and little blur can be obtained from long distances to very close distances, and a wide eye box can be maintained. Also, the thickness of the deep-focus glasses can be made the same as that of normal glasses.

The deep-focus glasses can also reduce eyestrain, myopia, and axial myopia. In other words, in recent years, the number of people suffering from eyestrain and myopia due to factors in the living environment associated with the spread of books, television, smartphones, video games, and the like, is increasing. It is said that the time spent focusing on a short distance (20 cm to 1.5 m) is long, which causes eyestrain due to overuse of the ciliary muscle, and that deformation of the eyeball and elongation of the eye axis occur to make it easier to focus on a short distance, causing myopia and axial myopia. For example, the recommended distance when reading a book or looking at a smartphone screen is generally about 40 cm. At this distance, characters and images are easy to see and the eyes are unlikely to be overburdened. However, there are many cases where the characters or images are viewed closer to the eyes than the recommended distance. By bringing the characters or images closer to the eyes, the proportion of the book or smartphone screen in the field of view increases. In particular, when the characters or images are small, the proportion of people who view the characters or images closer to the eyes increases, which also increases the strain on the eyes. With the deep-focus glasses, the radiation angle of the transmitted light can be controlled to a certain value or less by designing the transparent column 31 that serves as a collimator. For example, if the radiation angle of the transmitted light from the transparent column 31 is designed to be 1.15 degrees or less (aspect ratio is about 100), the radiation angle of the transmitted light is almost the same as the radiation angle of light incident on a pupil with a diameter of 8 mm from a light source about 40 cm or more away. In this case, the user of the deep-focus glasses can focus on an object (characters and images) about 40 cm away and see it even if the distance between the eyes and a book, smartphone, and the like is brought closer to 40 cm or less. By bringing it closer to the eyes, its ratio to the field of vision increases, so it is equivalent to magnifying the object, but no magnifying lenses are required and there is no increased strain on your eyes. In addition, because the deep-focus glasses do not use lenses to correct vision, they can be worn by healthy people without eye disorders such as myopia or presbyopia, and can be used as a device to prevent eyestrain and myopia. Furthermore, if the material used in the deep-focus glasses is given an ultraviolet ray blocking function, it can also help prevent eye diseases caused by ultraviolet rays (ultraviolet keratitis, pinguecula, and the like).

### THE SECOND EMBODIMENT

### XR Glasses

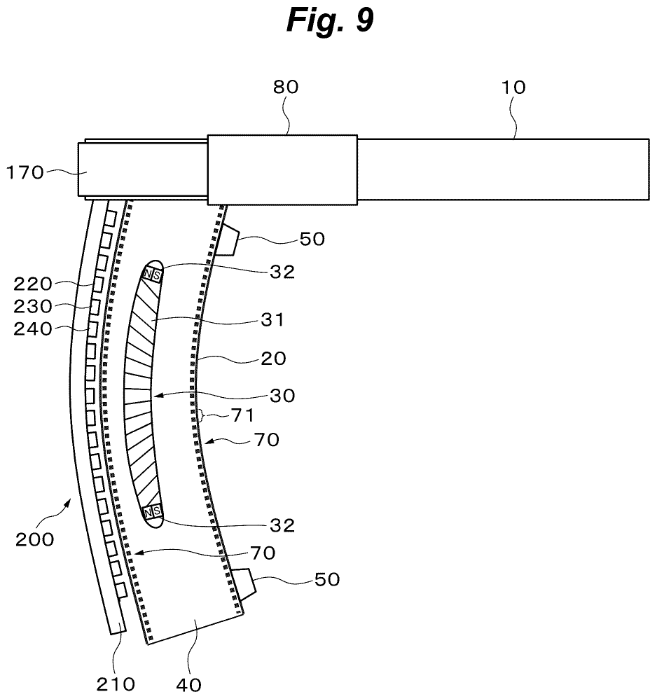

FIG. 9 is a left side view showing the XR glasses according to the second embodiment. Since the XR glasses are configured symmetrically, the configuration of the left-eye side will be described below.

As shown in FIG. 9, in the XR glasses, a near-eye display 200 is provided on the front of a left-eye housing 20 similar to the deep-focus glasses according to the first embodiment. The near-eye display 200 may be curved to follow the left-eye housing 20 or flat. The near-eye display 200 is opaque or semi-transparent. In the near-eye display 200, a two-dimensional array of pixels is provided on an opaque or semi-transparent substrate 210, the pixel being composed of three sub-pixels, each of which is composed of a red-light emitting area 220, a green-light emitting area 230, and a blue-light emitting area 240. These light-emitting areas 220, 230, and 240 are micro light emitting diodes in a micro light emitting diode display, organic EL elements in an organic EL display, and laminated structures of a transparent conductive film, an alignment film, liquid crystal, a color filter, and the like formed on a substrate in a liquid crystal display. The size of one pixel is selected as necessary, and is, for example, 4 to 6 μm. A left-eye sensor unit 170 is provided adjacent to a control circuit unit 80 on the side or front of the frame 10. The left-eye sensor unit 170 includes, for example, one or more of an image sensor (such as a CMOS image sensor or a CCD), a LiDAR, an illuminance sensor, an acceleration sensor, a gyro sensor, a geomagnetic sensor, an infrared sensor, and the like. When an infrared sensor is used, it can be seen even in a dark place. In addition, audio equipment such as a speaker, a bone conduction earphone, a microphone, and the like is also provided on the frame 10 near the ear as necessary.

In the case of the XR glasses, the design condition of the transparent columns 31 of the transparent column assembly 30 is preferably a condition of θ≤2.0 degrees, that is, L/D_{Outer}≥57.3. The narrower the angle θ, the higher the deep-focus property, and the problem of the inconsistency between the convergence angle and the focal length, which is often a problem with VR glasses, and the like can be reduced. However, since narrowing the angle θ reduces the amount of light transmitted through the transparent column 31, it is desirable for the angle θ to be 0.1 degrees or more. It is also possible to increase the amount of transmitted light by narrowing the radiation angle of light in advance by installing a micro lens array before the light enters the transparent column assembly 30, but details will be omitted.

Other than the above, the XR glasses are similar to the deep-focus glasses according to the first embodiment.

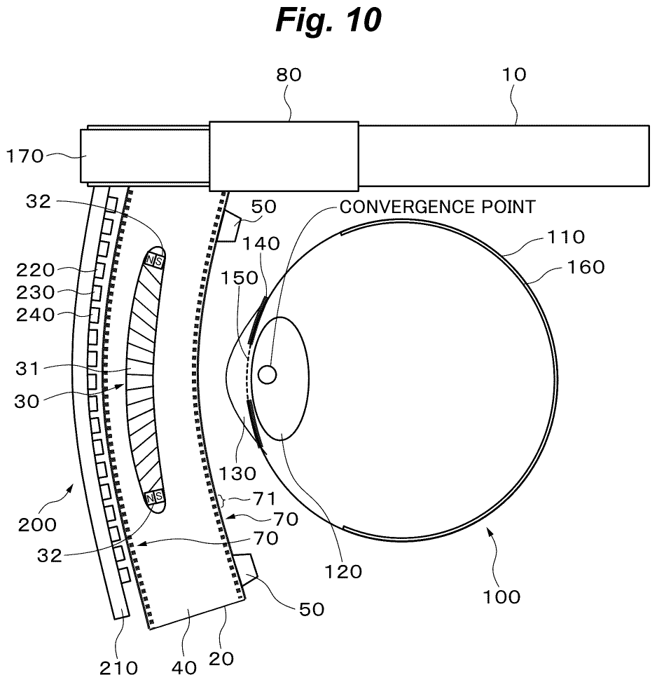

FIG. 10 shows the XR glasses when worn by a user.

### Operation of the XR Glasses

As shown in FIG. 10, the light emitted from the pixels of the near-eye display 200 and incident on the transparent column assembly 30 is narrowed by each transparent column 31 to a radiation angle of substantially 5 degrees or less (preferably 2.0 degrees or less), passes through the convergence point, and then forms an image on the retina 160. In the XR glasses, as in FIG. 7, even when the line of sight is directed downward and the eyeball 410 is rotated compared to FIG. 10, the transparent column assembly 30 can be moved by magnetic force inside the liquid 40 of the left-eye housing 20 so that the light transmitted through the transparent column assembly 30 can reliably pass through the pupil 150. This makes it possible to maintain a wide eyebox.

According to the XR glasses of the second embodiment, by viewing the image on the near-eye display 200 through the transparent column assembly 30 that can narrow the radiation angle of the incident light within 5 degrees substantially, it becomes possible to recognize images at an overwhelmingly closer distance than with conventional optical systems, and it is possible to realize VR glasses, MR glasses, AR glasses, SR glasses, and the like that are not bulky and have a thickness not much different from that of normal glasses.

### THE THIRD EMBODIMENT

### Deep-Focus Glasses

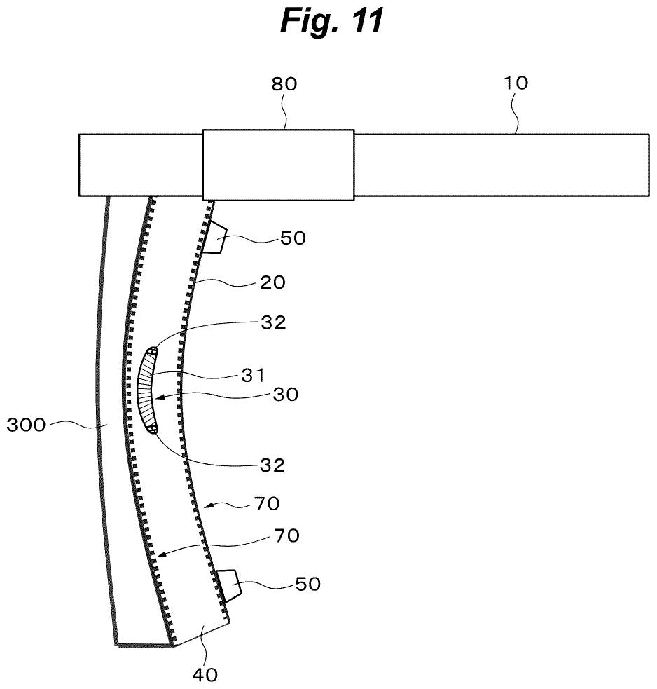

FIG. 11 is a left side view showing deep-focus glasses according to the third embodiment. Since the deep-focus glasses are configured symmetrically, the configuration of the left eye side will be described below.

As shown in FIG. 11, in the deep-focus glasses, a concave lens 300 curved to follow the left-eye housing 20 is provided on the front surface of the left-eye housing 20 similar to that of the deep-focus glasses according to the first embodiment. Except for the transparent column assembly 30, the deep-focus glasses are otherwise similar to the deep-focus glasses according to the first embodiment.

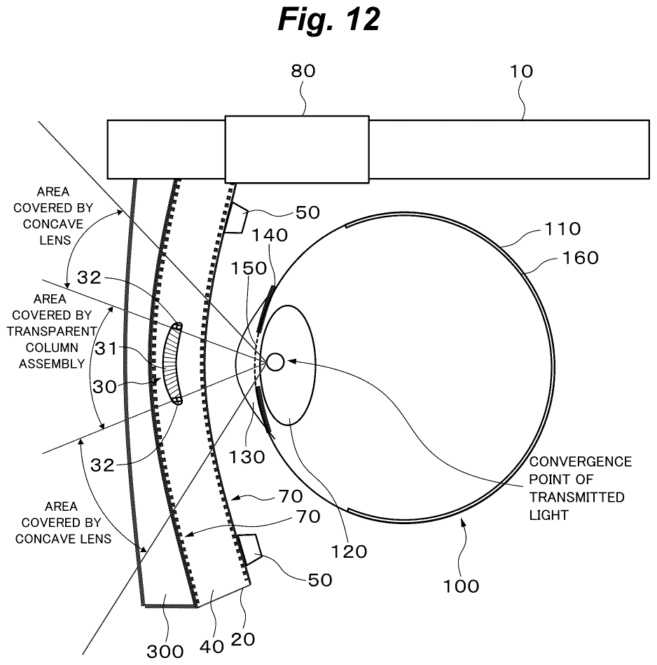

FIG. 12 shows a state when the deep-focus glasses are worn by a user. As shown in FIG. 12, in the deep-focus glasses, the field of view within the range of angles from the convergence point to the transparent column assembly 30 is covered by the transparent column assembly 30, and the field of view outside of that is covered by the concave lens 300. The field of view of one eye of a person with normal eyesight is in the range of 60 degrees above, 70 degrees below, 60 degrees on the nose side, and 100 degrees on the ear side, but the area of central vision where shapes, colors, and the like can be clearly recognized is very small, so the area covered by the transparent column assembly 30 is limited to, for example, about ±10 degrees, and a wider range is covered by the normal concave lens 300.

### Operation of the Deep-Focus Glasses

The operation of the deep-focus glasses is similar to that of the deep-focus glasses of the first embodiment, except that the field of view within the angular range from the convergence point to the transparent column assembly 30 is covered by the transparent column assembly 30, and the field of view outside of that is covered by the concave lens 300.

According to the deep-focus glasses of the third embodiment, by combining the left-eye housing 20 and the right-eye housing having the transparent column assembly 30 with the concave lens 300, it is possible to obtain performance equivalent to that of the deep-focus glasses of the first embodiment.

### THE FOURTH EMBODIMENT

### Deep-Focus Glasses

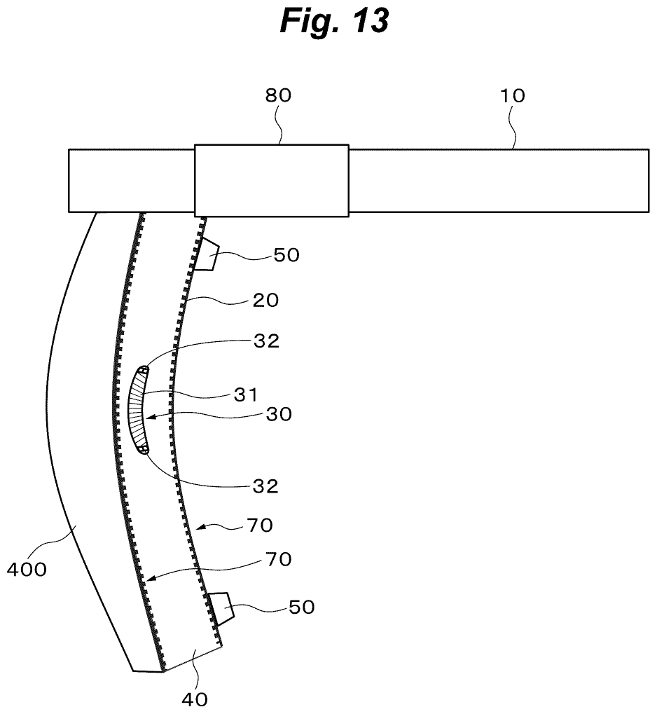

FIG. 13 is a left side view showing deep-focus glasses according to the fourth embodiment. Since the deep-focus glasses are configured symmetrically, the configuration of the left-eye side will be described below.

As shown in FIG. 13, in the deep-focus glasses, a convex lens 400 curved to follow the left-eye housing 20 is provided on the front surface of the left-eye housing 20 similar to that of the deep-focus glasses according to the first embodiment. Except for the transparent column assembly 30, the deep-focus glasses are otherwise similar to the deep-focus glasses according to the first embodiment.

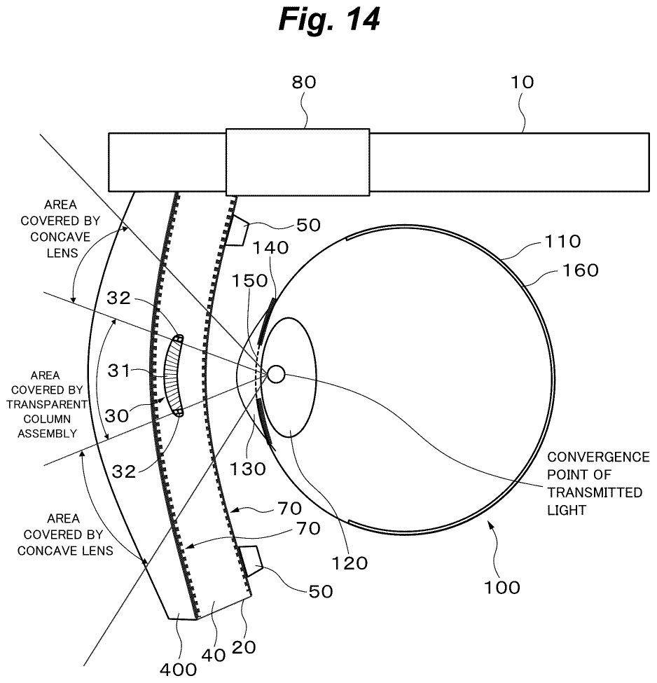

FIG. 14 shows a state when a user wears the deep-focus glasses. As shown in FIG. 14, in the deep-focus glasses, the field of view within the range of angles from the convergence point to the transparent column assembly 30 is covered by the transparent column assembly 30, and the field of view outside of that is covered by the convex lens 400. The field covered by the transparent column assembly 30 is limited to, for example, about ±10 degrees, and a wider range is covered by the normal convex lens 400.

### Operation of the Deep-Focus Glasses

The operation of the deep-focus glasses is similar to that of the deep-focus glasses of the first embodiment, except that the field of view within the angular range from the convergence point to the transparent column assembly 30 is covered by the transparent column assembly 30, and the field of view outside of that is covered by the convex lens 400.

According to the deep-focus glasses of the fourth embodiment, by combining the left-eye housing 20 and the right-eye housing having the transparent column assembly 30 with the convex lens 400, it is possible to obtain performance equivalent to that of the deep-focus glasses of the first embodiment.

### THE FIFTH EMBODIMENT

### Deep-Focus Glasses

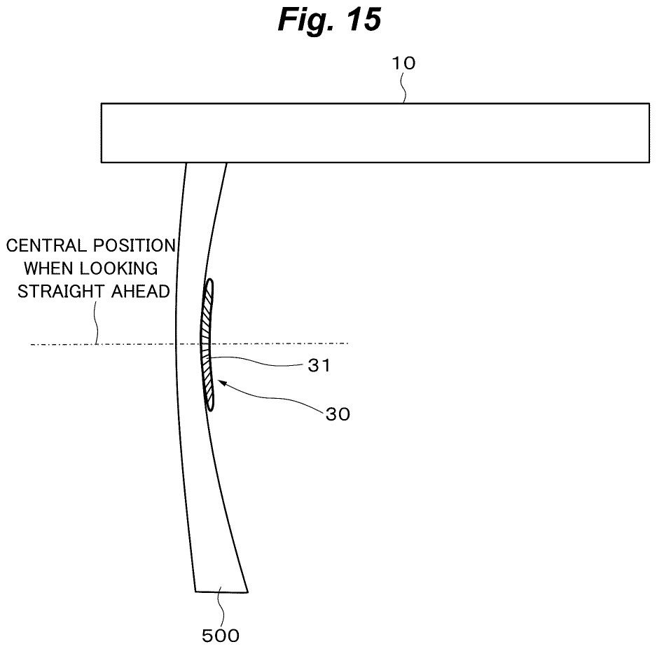

FIG. 15 is a left side view showing deep-focus glasses according to the fifth embodiment. Since the deep-focus glasses are configured symmetrically, the configuration of the left-eye side will be described below.

As shown in FIG. 15, in the deep-focus glasses, a transparent column assembly 30 curved to follow a lens 500 that is integral with a frame 10 is provided on the rear surface of the lens 500. The lens 500 may be a convex lens or a concave lens, and may have a prescription or no prescription. FIG. 15 shows a case where the lens 500 is a concave lens. Unlike the deep-focus glasses according to the first embodiment, the deep-focus glasses do not have a left-eye housing 20, do not have a function for moving the transparent column assembly 30, and do not use an eye tracking sensor.

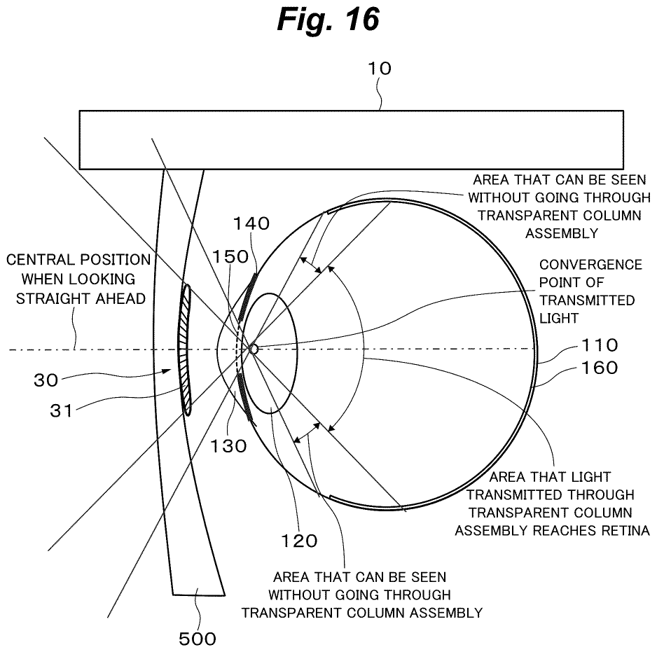

FIG. 16 shows a state when the deep-focus glasses are worn by a user. As shown in FIG. 16, in the deep-focus glasses, the field of view within the range of angles from the convergence point to the transparent column assembly 30 is covered by the transparent column assembly 30, and the field of view outside of that is covered by the lens 500.

### Operation of the Deep-Focus Glasses

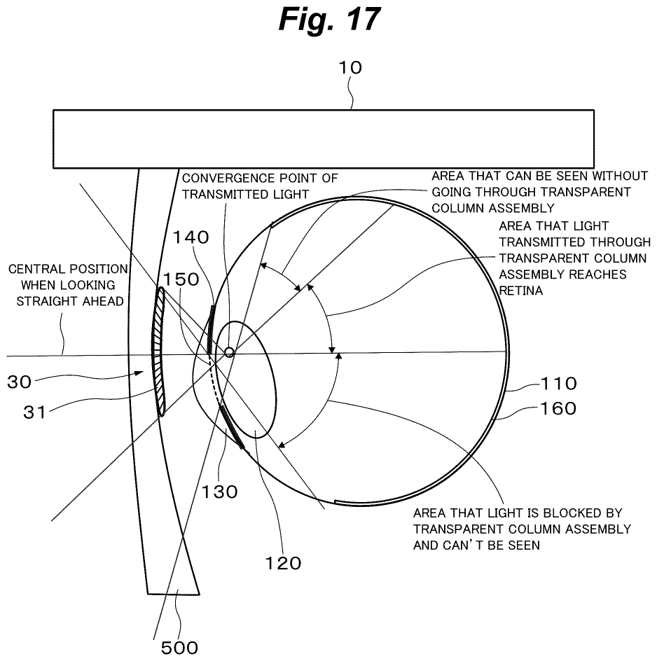

In the deep-focus glasses, the field of view within the range of angles from the convergence point to the transparent column assembly 30 is covered by the transparent column assembly 30, and the field of view outside of that is covered by the lens 500. As shown in FIG. 17, when the line of sight is directed downward and the eyeball 100 rotates, the area where the light transmitted through the transparent column assembly 30 reaches the retina 160 becomes narrower than in the case of FIG. 16.

The deep-focus glasses according to the fifth embodiment can obtain the following advantages. That is, as shown in FIG. 16, when the transparent column assembly 30 is fixed at the center position when the user looks from the front, even if the user moves his/her line of sight (pupil 150) slightly, a region is generated in which the light that should enter the field of vision is blocked by the transparent column assembly 30 and cannot be seen. However, in daily life (such as when reading a book or newspaper slowly) where the user does not need to move the eyeball 100 vigorously, such as when playing vigorous exercise or games, the user can move the head or neck without moving the pupil 150 much and view the object (things, characters, and the like) in a state close to normal vision. In that case, it is possible to omit the movement function of the transparent column assembly 30 using an eye tracking sensor, and deep-focus glasses can be realized at low cost.

### THE SIXTH EMBODIMENT

### XR Glasses

The XR glasses according to the sixth embodiment is a combination of an XR glasses main body and a contact lens with collimation function that is attached to the cornea of the eye.

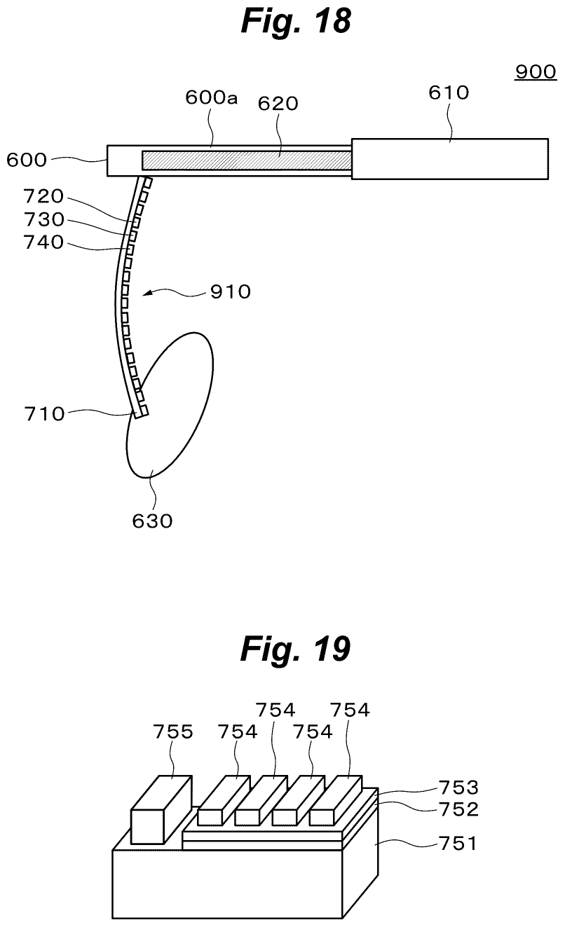

FIG. 18 is a right side view showing the XR glasses main body 900. Since the XR glasses main body 900 is configured symmetrically, the configuration on the left-eye side will be described below.

As shown in FIG. 18, in the XR glasses main body 900, a semi-transparent micro LED display 910 for XR glasses is provided behind a transparent windshield (not shown) for the left eye that is integrated with the frame 600 integrally with the windshield as a left-eye display unit for XR glasses. In the semi-transparent micro LED display 910 for XR glasses, pixels are arranged in a two-dimensional matrix on a flexible, curved, transparent wiring substrate 710 to provide a pixel array. One pixel has three sub-pixels, and each of these sub-pixels has one red-light emitting micro LED 720, one green-light emitting micro LED 730, and one blue-light emitting micro LED 740. These micro LEDs 720, 730, and 740 are all horizontal, and have the same structure, shape, and size. The micro LED 720 is an AlGaInN-based LED or an AlGaInP-based LED, and the micro LEDs 730 and 740 are AlGaInN-based LEDs. The pixel size is, for example, 4 to 6 μm square (corresponding to 4000 to 6000 PPI), but is not limited to this.

Micro LEDs 720, 730, and 740 are shown in FIG. 19. As shown in FIG. 19, in the micro LEDs 720, 730, and 740, a light emitting layer 752 and a p-type semiconductor layer 753 are sequentially laminated on an n-type semiconductor layer 751 except for a part, four p-side electrodes 754 made of metal are provided in a row on the p-type semiconductor layer 753, and an n-side electrode 755 made of metal is provided on the n-type semiconductor layer 751 in a portion adjacent to the light emitting layer 752 and the p-type semiconductor layer 753. The micro LEDs 720, 730, and 740 may have semiconductor layers other than the n-type semiconductor layer 751, the light emitting layer 752, and the p-type semiconductor layer 753, as necessary. In the micro LEDs 730 and 740, the n-type semiconductor layer 751 is an n-type GaN layer, the p-type semiconductor layer 753 is a p-type GaN layer, and the light emitting layer 752 has an InₓGa₁₋ₓN/In_{y}Ga_{1-y}N multiple quantum well (MQW) structure (x<y, 0≤x<1, 0≤y<1) in which InₓGa₁₋ₓN layers as barrier layers and In_{y}Ga_{1-y}N layers as well layers are alternately stacked, with the In composition ratios x and y being selected according to the emission wavelength of green or blue. When the micro LED 720 is an AlGaInN-based LED, the n-type semiconductor layer 751, the light emitting layer 752, and the p-type semiconductor layer 753 have the same structures as the micro LEDs 730 and 740. When the micro LED 720 is an AlGaInP-based LED, the n-type semiconductor layer 751 is an n-type AlGaInP layer, the p-type semiconductor layer 753 is a p-type AlGaInP layer, and the light emitting layer 752 has an InₓGa₁₋ₓP/In_{y}Ga_{1-y}P MQW structure, with the In composition ratios x and y being selected according to the emission wavelength of red. The p-side electrode 754 and the n-side electrode 755 are at the same height. Although not shown, a Sn film is provided on the p-side electrode 754 and the n-side electrode 755 to be used when mounting the micro LED chips 720, 730, and 740 on the wiring substrate 710.

As shown in FIG. 18, the ear hook 600a on the left side of the frame 600 is provided with a control circuit unit 610 for controlling the operation of the semi-transparent micro LED display 900, surrounding the outer periphery of the ear hook 600a. A flexible wiring 620 is provided on the side of the ear hook 600a. The flexible wiring 620 wires between the control circuit unit 610 and the semi-transparent micro LED display 910 for XR glasses. The windshield except for the part corresponding to the semi-transparent micro LED display 910 for XR glasses can be used as a wiring area. A battery (such as a lithium ion battery) used as a power source is attached to any part of the frame 600 (such as the ear hook 600a), but is not limited to this. A power source or a complex control circuit unit, which tends to be bulky, may be connected to the main body (frame 600) by providing a separate base, such as hanging it around the neck. A nose pad 630 is provided on the nose side of the frame 600. If necessary, a left-eye sensor is provided on the frame 600, for example, directly above the windshield. The left-eye sensor includes, for example, one or more of a left-eye image sensor (such as a CMOS image sensor or a CCD), a LIDAR, an illuminance sensor, an acceleration sensor, a gyro sensor, a geomagnetic sensor, a near-infrared camera for eye tracking, and the like.

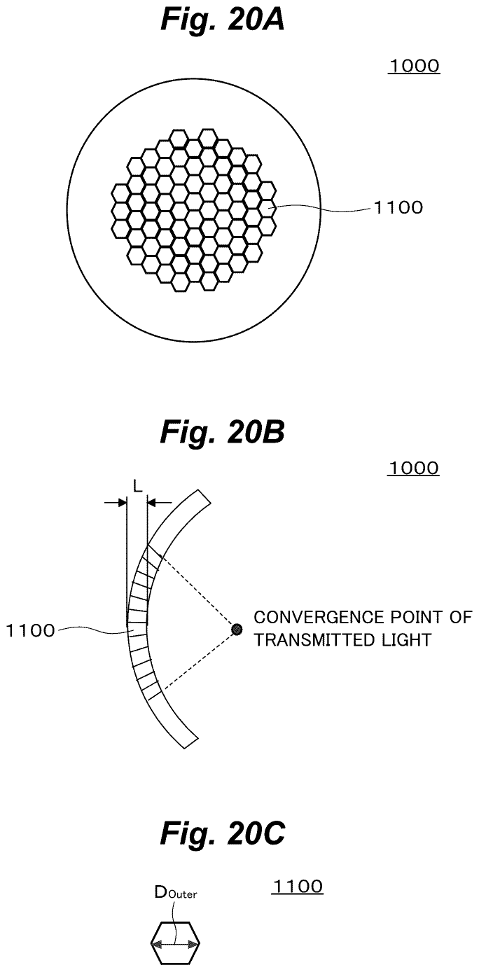

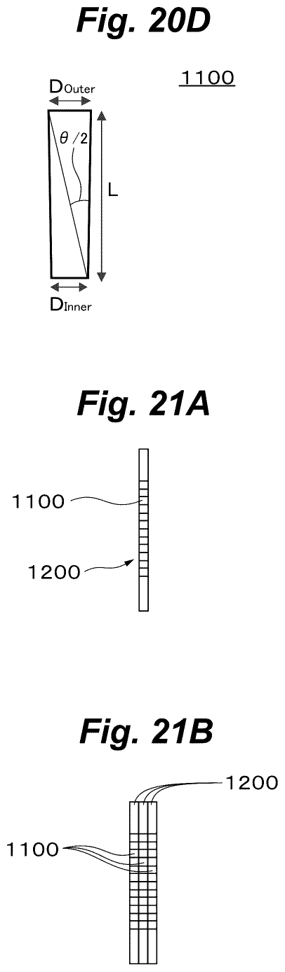

FIG. 20A, FIG. 20B, FIG. 20C and FIG. 20D show a contact lens 1000 with collimation function. FIG. 20A and FIG. 20B are a plan view and a cross-sectional view of the contact lens 1000 with collimation function, respectively. FIG. 20C and FIG. 20D are a plan view and a side view of a transparent column 1100 of a transparent column assembly that constitutes the contact lens 1000 with collimation function, respectively.

As shown in FIG. 20A and FIG. 20B, the contact lens 1000 with collimation function has an overall bowl-shaped curved shape that corresponds to the curvature of the surface of the cornea.

In the center of the contact lens 1000 with collimation function, a large number of transparent columns 1100 in the shape of a regular hexagonal truncated pyramid as shown in FIG. 20C and FIG. 20D are arranged in a honeycomb shape with their sides in close contact with each other to form a transparent column assembly. The curved outer and inner surfaces of the contact lens 1000 with collimation function are smoothly formed. If the diagonal length of the outer surface of the transparent column 1100 is denoted as D_{Outer} and the diagonal length of the inner surface is denoted as D_{Inner}, then D_{Outer}>D_{Inner}.

As shown in FIG. 20B, the light passing through each transparent column 1100 constituting the transparent column assembly is configured to converge to one point (convergence point). The convergence point where the light passing through each transparent column 1100 converges is set to be near the center of the crystalline lens 120 when the contact lens 1000 with collimation function is attached to the cornea 130.

The contact lens 1000 with collimation function is configured so that the radiation angle of light from each transparent column 1100 is within 5 degrees. As shown in FIG. 20C and FIG. 20D, if the diagonal length of the transparent column 1100 is denoted as D, the length is denoted as L, and half the radiation angle is denoted as θ/2, then, for example, if D=4 μm and L=92 μm, then light with a radiation angle θ of within 5 degrees (±2.5 degrees) will pass through the contact lens 1000 with collimation function.

The transparent material of the contact lens 1000 with collimation function is, for example, thermoplastic acrylic resin (PMMA) or polycarbonate (PC) resin, and the light-absorbing film on the side of the transparent column 1100 can be made of black color resist, a material made of a thermoplastic resin mixed with carbon black, and the like.

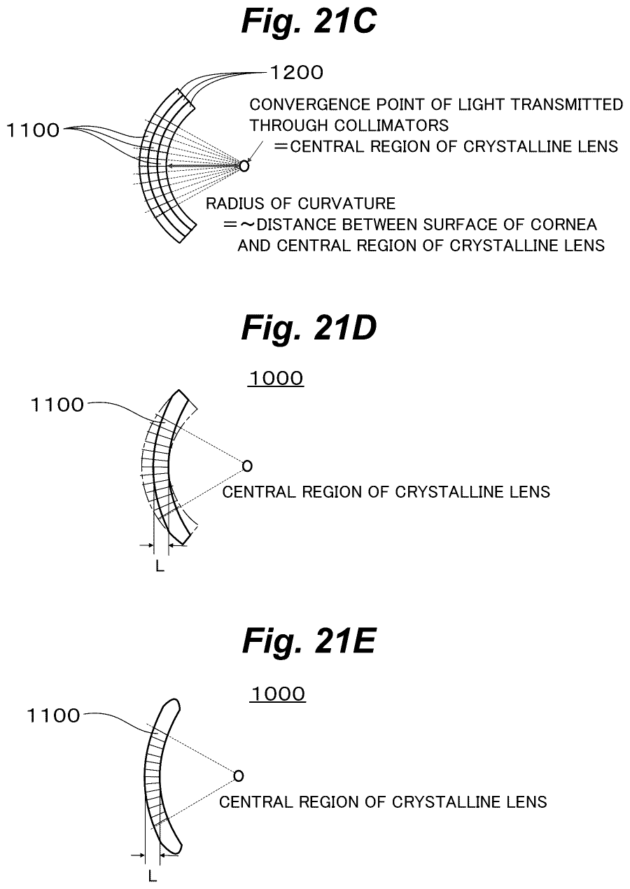

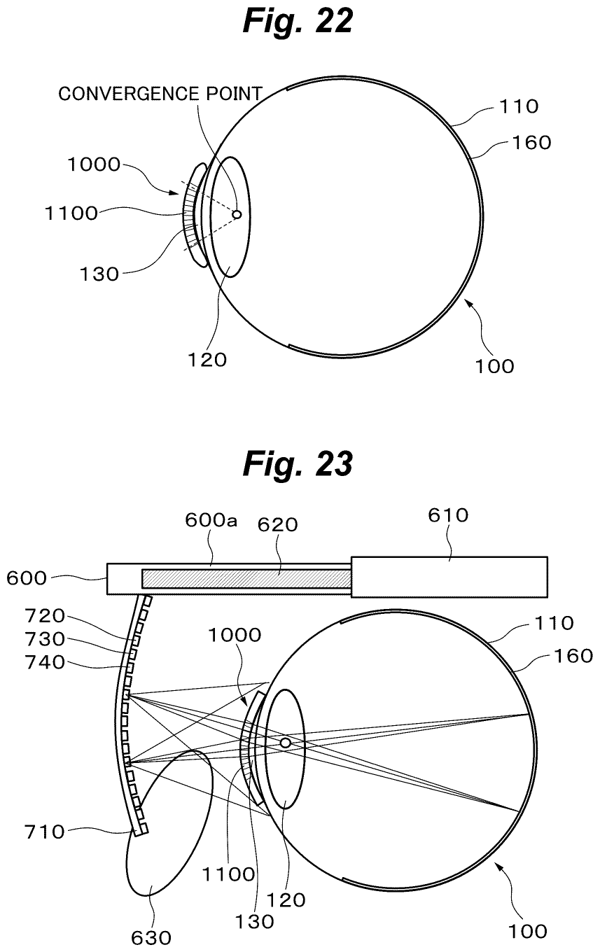

In order to realize a radiation angle of 5 degrees or less, the aspect ratio of the transparent columns 1100 serving as collimators must be increased to about 23 or more, and it is difficult to collectively form them. Therefore, for example, as shown in FIG. 21A, a flat and stretchable transparent layer 1200 is formed having a transparent column assembly consisting of transparent columns 1100 in the shape of regular hexagonal columns whose side walls are formed of a light-absorbing film (not shown), and this is stacked in multiple layers (three layers in this example) as shown in FIG. 21B to form a thick film of a transparent column assembly with collimation function with a sufficient thickness to make the radiation angle 5 degrees or less. The thick film is cut into a disk shape of an appropriate size as a contact lens, and is heated and molded to be curved. This state is shown in FIG. 21C. By this process, the opening area of the transparent column assembly becomes a shape that is wide on the outside of the curved surface and narrow on the inside. The convergence point of the light passing through the transparent column assembly can be adjusted by the radius of curvature of the curve at this time. If the convergence point is to be near the center of the crystalline lens, the radius of curvature is set to approximately the distance between the surface of the cornea 130 and the center of the crystalline lens 120. When the curved shape of the thick film differs from the shape of the cornea 130, as shown in FIG. 21D, the excess portion of the inner curved surface of the thick film is ground to match the shape of the cornea 130. Grinding of the outer curved surface is not necessary when the curvature is the same as that of the cornea 130, but FIG. 21D shows a case where grinding of the outer curved surface has been performed. In this manner, the contact lens 1000 with collimation function is manufactured. If necessary, the outer periphery of the contact lens 1000 with collimation function is chamfered as shown in FIG. 21E. FIG. 22 shows a state in which the contact lens 1000 with collimation function shown in FIG. 21E is attached to the cornea 130.

FIG. 23 shows a state when the XR glasses are configured by placing the XR glasses main body 900 in front of the user's eyes and placing the contact lens 1000 with collimation function on the cornea 130.

### Operation of the XR Glasses

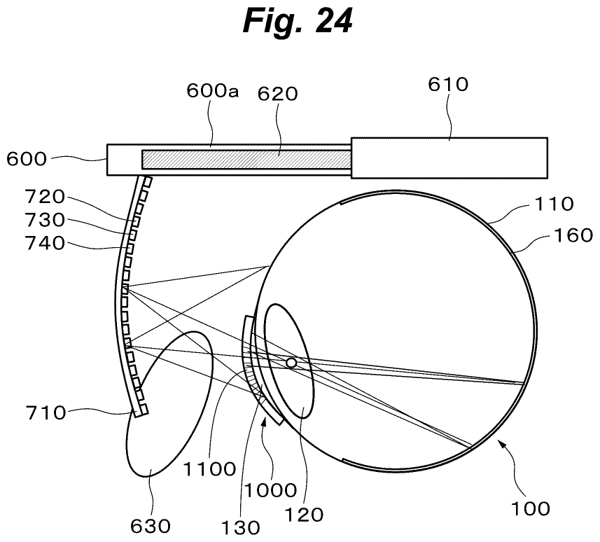

As shown in FIG. 24, the light from the pixels of the Semi-transparent micro LED display 910 for XR glasses has a large radiation angle because there is no collimator, but when it enters the contact lens 1000 with collimation function, the radiation angle is substantially narrowed within 5 degrees, so that the light from adjacent pixels is imaged on the retina without significantly mixing with each other. As shown in FIG. 24, even if the line of sight is directed downward and the eyeball 110 rotates, the light from the pixels of the semi-transparent micro LED display 910 for XR glasses has a large radiation angle, and light with an angle that can enter the pupil is present in a wide range, so a wide eyebox can be maintained.

According to the XR glasses of the sixth embodiment, even if a collimator-free semi-transparent micro LED display 910 for XR glasses is used, the contact lens 1000 with collimation function can narrow the radiation angle of light from the pixels to 5 degrees or less, so that an image can be displayed with sufficient resolution. In addition, according to the XR glasses, as in the first embodiment, eyestrain, myopia, and axial myopia can be reduced. That is, since the contact lens 1000 with collimation function does not correct vision by lens function, even healthy people without eye disorders such as myopia or presbyopia can use it in daily life as a deep-focus contact lens that provides clear vision with little blur from long distances to very close distances, and even when viewing an object at a close distance, overuse of the ciliary muscle is suppressed, so eyestrain, myopia, and axial myopia can be reduced. Furthermore, if the material of the contact lens 1000 with collimation function is given an ultraviolet ray blocking function, it can also prevent eye diseases caused by ultraviolet rays (ultraviolet keratitis, pinguecula, and the like).

Heretofore, embodiments of the present invention have been explained specifically. However, the present invention is not limited to these embodiments, but contemplates various changes and modifications based on the technical idea of the present invention.

For example, numerical numbers, structures, shapes, materials, methods, and the like presented in the aforementioned embodiments are only examples, and the different numerical numbers, structures, shapes, materials, methods, and the like may be used as necessary.

### EXPLANATION OF REFERENCE NUMERALS

10 frame
20 left-eye housing
30 transparent column assembly
31 transparent column
32 micro magnet
40 liquid
50 eye tracking sensor
60 transparent layer
70 coil array substrate
71 micro coil
80 control circuit unit
170 left-eye sensor unit
200 near-eye display
210 substrate
220 red-light emitting area
230 green-light emitting area
240 blue-light emitting area
300 concave lens
400 convex lens
500 lens
900 XR glasses main body
910 semi-transparent micro LED Display for XR glasses
1000 contact lens

1. Deep-focus glasses, comprising:
a transparent left-eye housing and a transparent right-eye housing that are integral with a frame,
a transparent column assembly that is movably housed in the left-eye housing and the right-eye housing, respectively; and
at least one eye tracking sensor that is attached to each of the left-eye housing and the right-eye housing,
the transparent column assembly being configured such that a plurality of transparent columns serving as collimators are arranged, the transparent columns having a radiation angle of 5 degrees or less for 50% or more of transmitted light with respect to incident light, and the light transmitted through each transparent column is converged to a convergence point,
the deep-focus glasses having the function of moving the transparent column assembly inside the left-eye housing and the right-eye housing so that it faces the pupil and the convergence point is located on the surface or inside of the cornea, inside the pupil, on the surface or inside of the crystalline lens, or inside the eyeball, depending on the result of detection of the position of the pupil of the user's eye by the eye tracking sensor.

2. The deep-focus glasses according to claim 1, wherein the inside of the left-eye housing and the-right eye housing is filled with a liquid having a refractive index equal to that of the transparent column, and the transparent column assembly is suspended in the liquid.

3. The deep-focus glasses according to claim 1, wherein the transparent column assembly is movable by magnetic or electrical force.

4. The deep-focus glasses according to claim 3, wherein micro magnets are attached to a plurality of positions of the transparent column assembly, and a plurality of micro coils are attached to at least one of the front and rear surfaces of the left-eye housing and the right-eye housing so that they can be driven independently.

5. The deep-focus glasses according to claim 4, wherein the plurality of micro coils are arranged in a two-dimensional array.

6. The deep-focus glasses according to claim 1, wherein the micro magnets are attached to at least three positions of the transparent column assembly.

7. The deep-focus glasses according to claim 1, wherein the eye tracking sensor is attached to four corners of the left-eye housing and the right-eye housing.

8. XR glasses, comprising:
a transparent left-eye housing and a transparent right-eye housing that are integral with a frame,
a transparent column assembly that is movably housed in the left-eye housing and the right-eye housing, respectively,
at least one eye tracking sensor that is attached to each of the left-eye housing and the right-eye housing; and
an opaque or semi-transparent left-eye display and an opaque or semi-transparent right-eye display that are provided on a front surface of the left-eye housing and the right-eye housing, respectively,
the transparent column assembly being configured such that a plurality of transparent columns serving as collimators are arranged, the transparent columns having a radiation angle of 5 degrees or less for 50% or more of transmitted light with respect to incident light, and the light transmitted through each transparent column is converged to a convergence point,
the XR glasses having the function of moving the transparent column assembly inside the left-eye housing and the right-eye housing so that it faces the pupil and the convergence point is located on the surface or inside of the cornea, inside the pupil, on the surface or inside of the crystalline lens, or inside the eyeball, depending on the result of detection of the position of the pupil of the user's eye by the eye tracking sensor.

9. The XR glasses according to claim 8, wherein the inside of the left-eye housing and the-right eye housing is filled with a liquid having a refractive index equal to that of the transparent column, and the transparent column assembly is suspended in the liquid.

10. The XR glasses according to claim 8, wherein the transparent column assembly is movable by magnetic or electrical force.

11. The XR glasses according to claim 8, wherein micro magnets are attached to a plurality of positions of the transparent column assembly, and a plurality of micro coils are attached to at least one of the front and rear surfaces of the left-eye housing and the right-eye housing so that they can be driven independently.

12. The XR glasses according to claim 11, wherein the plurality of micro coils are arranged in a two-dimensional array.

13. The XR glasses according to claim 8, wherein the micro magnets are attached to at least three positions of the transparent column assembly.

14. The XR glasses according to claim 8, wherein the eye tracking sensor is attached to four corners of the left-eye housing and the right-eye housing.

15. The XR glasses according to claim 8, wherein the left-eye display and the right-eye display are liquid crystal displays, organic electroluminescent displays, or micro light emitting diode displays.

16-19: (canceled)
